(19) United States
(12) Patent Application Publication
(10) Pub. No.: US 2024/0012769 A1
(43) Pub. Date: Jan. 11, 2024

(54) NETWORK INTERFACE DEVICE AS A COMPUTING PLATFORM

(71) Applicant: Intel Corporation, Santa Clara, CA (US)

(72) Inventors: Francesc GUIM BERNAT, Barcelona (ES); Manish DAVE, Folsom, CA (US); Vered BAR BRACHA, Somerville, MA (US); Bradley A. BURRES, Newton, MA (US); Uzair QURESHI, Gilbert, AZ (US); Joseph GRECCO, Saddle Brook, NJ (US); Paul KAPPLER, Hillsboro, OR (US); Dirk F. BLEVINS, Russell Springs, KY (US); Mukesh Gangadhar BHAVANI VENKATESAN, Bangalore (IN); Hariharan M, Palakkad (IN); Marek PIOTROWSKI, Pepowo (PL); Dhanya PILLAI, Ennis (IE); John MANGAN, Shannon (IE); Mandar CHINCHOLKAR, Portland, OR (US); Eoin WALSH, Limerick (IE); Sumit MOHAN, San Jose, CA (US); Ned SMITH, Beaverton, OR (US); Tushar Sudhakar GOHAD, Phoenix, AZ (US)

(21) Appl. No.: 18/370,621

(22) Filed: Sep. 20, 2023

(30) Foreign Application Priority Data
Jul. 8, 2023 (IN) 202341046012

(51) Int. Cl. G06F 13/16; G06F 11/20

(52) U.S. Cl. CPC G06F 13/1668; G06F 11/2017; G06F 2201/80

(57) ABSTRACT

Examples described herein relate to a network interface device. In some examples, the network interface device includes a network interface, a direct memory access (DMA) circuitry, a host interface, memory, one or more processors, and circuitry to: based on a configuration of operation specifying a standalone operation, cause the network interface device to operate in standalone to execute one or more applications and based on a configuration of operation specifying a companion operation, cause the network interface device to operate in companion to provide at least one host system with access to one or more hardware resources accessible by the network interface device.

### RELATED APPLICATION

This application claims priority from Indian Provisional Patent Application No. 202341046012, entitled “NETWORK INTERFACE DEVICE AS A COMPUTING PLATFORM,” filed Jul. 8, 2023, in the Indian Patent Office. The entire contents of the Indian Provisional Patent Application are incorporated by reference in their entirety.

### BACKGROUND

The edge computing cluster and data center clusters encompass client usages such as smart cities, augment reality (AR)/virtual reality (VR), assisted/autonomous vehicles, retail, proximity triggered services, and other applications with a wide variety of workload behaviors and requirements. However, using a data center that is physically located miles from the client device can introduce latency in completing a work request. In addition, for a client device that is moving, such as in a car or other high speed vehicle, the client device can move into a compute cluster region and then out of the region rapidly. Devices that are in-motion pose a challenge of the need for even more rapid deployment of work by the cluster to provide data to the client device in a timely manner.

Some workloads rely on machine learning (ML) or deep learning (DL) inferences that are specialized for specific groups of requestors whereas some workloads use hardware accelerated execution to complete in the narrow time budgets. Some workloads can be performed as Function as a Service (FaaS) actions. Many workloads require proximity to specific data consumed in their operation, both due to speed and data movement challenges, while others may arise with special needs. For example, a wearable device may use an AR service from only a particular set of service providers that use a certain algorithm for high accuracy. As another example, an assisted driver may request a particular navigation service from a specific service provider.

Edge computing seeks to place compute and data storage resources physically closer to data sources and data receivers to reduce latency of processing and accessing data and reduce network bandwidth utilization. Edge cloud architectures utilize network interface devices such as Intel® Infrastructure Processing Units (IPUs) to manage the infrastructure and allow central processing units (CPUs), graphics processing units (CPUs), and other processors (e.g., xPU) to execute core application-level functions. Far edge can include distributed large scale devices (e.g., multitudes of edge appliances) but devices can be limited by power usage and space constraints. Data center edge can include devices with higher computing power and sharing of resources by multiple tenants. On premises edge can combine devices with both far and data center edge characteristics.

### BRIEF DESCRIPTION OF THE DRAWINGS

FIG. 1 depicts an example system.

FIG. 2 depicts an example system.

FIGS. 3A-3D depict example systems.

FIGS. 4A and 4B depict example deployment models.

FIG. 5 depicts example deployment models.

FIG. 6 depicts an example process.

FIG. 7 depicts an example network interface.

FIG. 8 depicts an example system.

### DETAILED DESCRIPTION

Edge cloud architectures can utilize network interface devices such as Intel® Infrastructure Processing Units (IPUs) to manage the infrastructure and allow central processing units (CPUs), graphics processing units (GPUs), and other processors (e.g., xPU) to execute core application-level functions. At least to provide for devices that are capable of utilization in far edge, data center edge, or on-premises environments, some examples provide a network interface device with capability to operate as a standalone computing platform system or that can be used as a companion to a server platform. Various examples provide a network interface device that can operate in one or more modes: Standalone System-on-Module mode, Standalone System mode, or Companion mode. Various examples can be used by telecommunications providers, communication service providers (CoSPs), and cloud service providers (CSPs).

Standalone System-on-Module mode can provide compute capabilities offloaded to a network interface device such as artificial intelligence (AI) inference and video analytics (e.g., image recognition, incident recognition, alert generation, decision making, commands to an autonomous vehicle, or others). Standalone System-on-Module mode can provide AI inference and video analytics and based on an increasing amount of compute demand (e.g., number of video streams received from one or more cameras and processed by a video analytics application), the network interface device can access attached accelerators to meet variations in demands and to provide modularity and flexibility. Standalone System mode can deploy a network interface device, independent from a host server, can access accelerators, processors (e.g., XPUs) over fabric, and non-volatile memory express (NVMe) over Fabric, or others, to dynamically create virtual systems with disaggregated resources to execute, heterogenous workloads and adjust to changing resource demands over time. Companion mode can provide network interface device to perform offloaded operations from a host, including execution of application formerly executed by the host in the event of a failure of the host to execute the application.

Some examples provide a network interface device as a standalone system with no connected host and the network interface device can execute workloads and access resources such as accelerators (e.g., field programmable gate arrays (FPGAs)), processors, memory, network interface, and others. A network interface device as a standalone system with no connected host can be utilized in Edge or non-edge (e.g., data center or cloud) deployments. Some examples provide a network interface device that includes: (1) media and AI accelerator circuitry accessible to a host server processor as virtual function (VF) or physical function (PF) (e.g., Single Root I/O Virtualization (SR-IOV) and Sharing specification or Intel® Scalable I/O Virtualization (SIOV)) to provide access to a network interface and AI processing; (2) AI accelerator circuitry in the network interface device to perform inline network analytics; and/or (3) processors to execute applications (e.g., virtual machines, containers, microservices, or other processes) in the network interface device by accessing AI circuitry or other resources.

Example deployments can be used in access edge, e.g., an edge compute tier where multiple Edge nodes may be connected. Connectivity between first tier of edges and access edge can utilize one Or more of: wireless connectivity which can be in standard wireless form or more specialized protocols such as 802.11) (Cellular V2X) or Lora; wired connectivity such as Ethernet; or LTE or 5G Wireless which can be provided in a private spectrum or telco spectrum.

Example deployments can be used in network edge, which can be mapped into base stations, street cabinets type of deployments. Network edge may be subject to strict security, space, thermal, and power usage limitations.

Note that while examples herein are described with respect to Edge or edge computing, examples can apply to any environments, such as data centers, servers within a rack, or other systems.

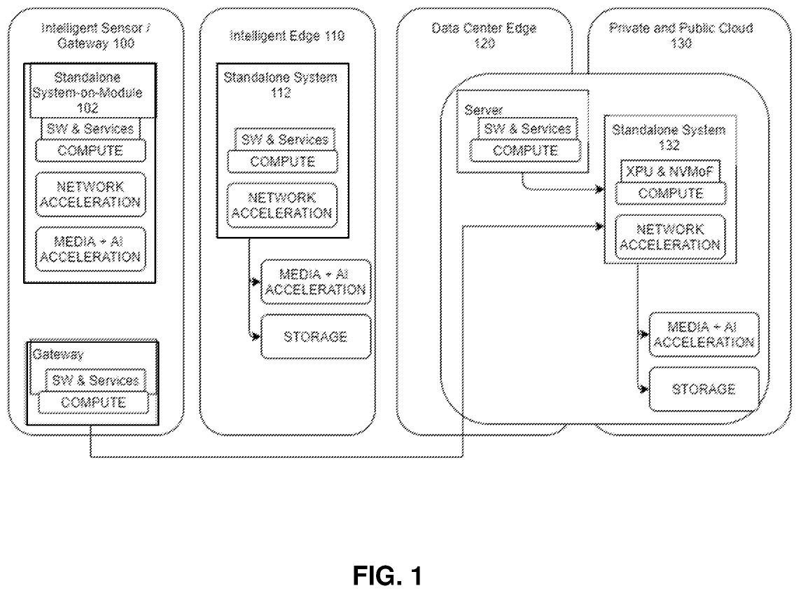

FIG. 1 depicts an example environment. For example, in an intelligent sensor or gateway 100, a network interface device can be deployed in Standalone System-on-Module mode 102 to provide software and services access to compute and media and AI accelerator devices. Services targeting intelligent gateway can include video analytics (e.g., cameras mounted to a pole or interact of things (JOT) gateway) or industrial control loops.

For example, in an intelligent edge system 110 a network interface device can be deployed in Standalone System mode 112 to provide software and services with access to compute and media and AI accelerator devices as well as storage resources. For example, in a data center 120 (e.g., edge), private, and/or public cloud environment 130, a network interface device can be deployed in Standalone System mode 132 to provide software and services with access to compute and media and AI accelerator devices as well as storage resources. A chassis height for standalone or companion mode implementations can be 1U or 2U (depending on space). Data centers that utilize network interface device can be hosted on-premise, at a telecommunication operators' central offices or governmental offices, or private cloud (last tier of the edge).

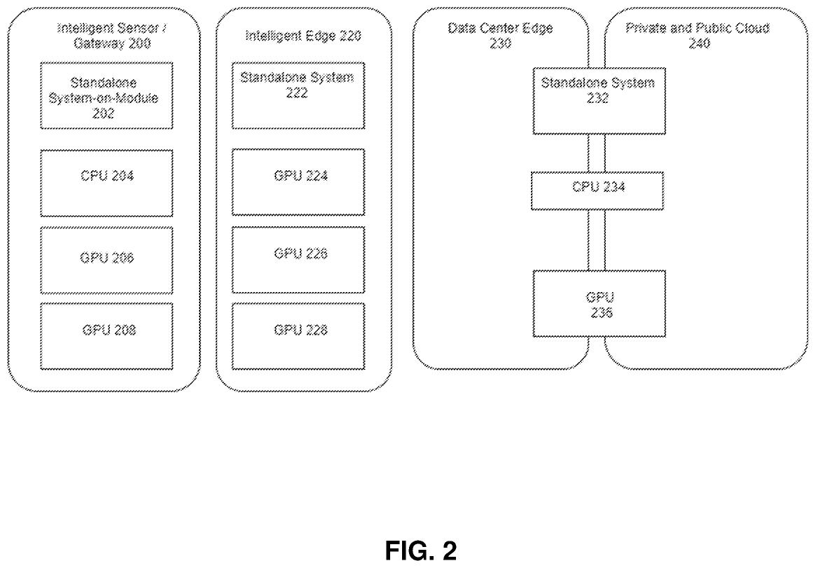

FIG. 2 depicts an example environment. For example, in an intelligent sensor or gateway 200, a network interface device can be deployed in Standalone System-on-Module mode 202 to provide software and services with access to hardware resources including CPU 204, GPU 206, and/or GPU 208. For example, in an intelligent edge system 220, a network interface device can be deployed in Standalone System mode 222 to provide software and services with access to hardware resources including GPU 224, GPU 226, and/or GPU 228. For example, in a data center 230 (e.g., edge), private, and/or public cloud environment 240, a network interface device can be deployed in Standalone System mode 232 to provide software and services with access to hardware resources including CPU 234, and/or GPU 236. Examples of software and services can include one or more of: video analytics, sensor processing (e.g., Light Detection and Ranging (LIDAR)), sensor processing, image detection, content delivery network (CDN), video analytics, or others.

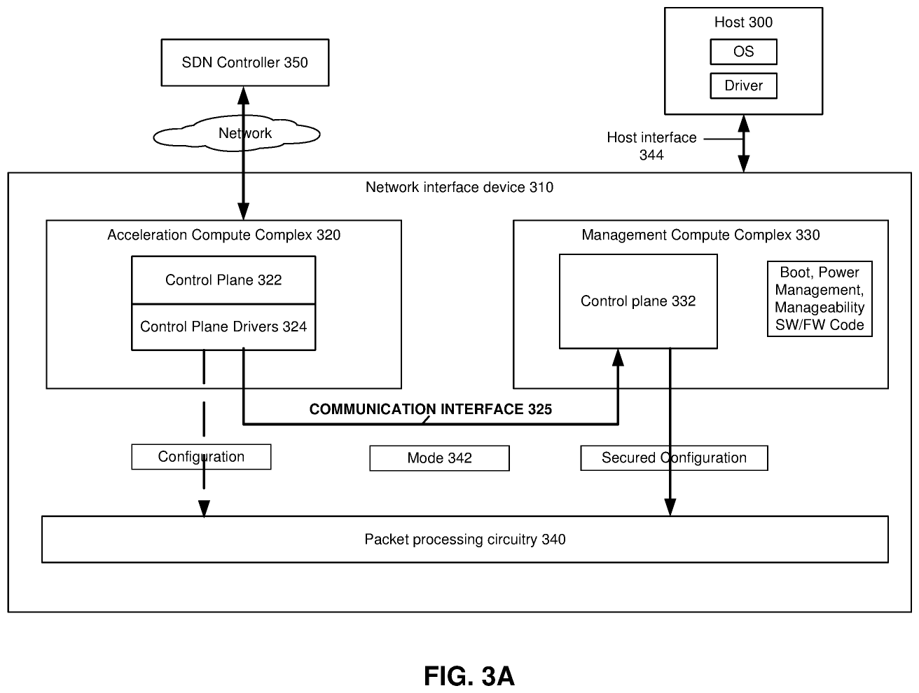

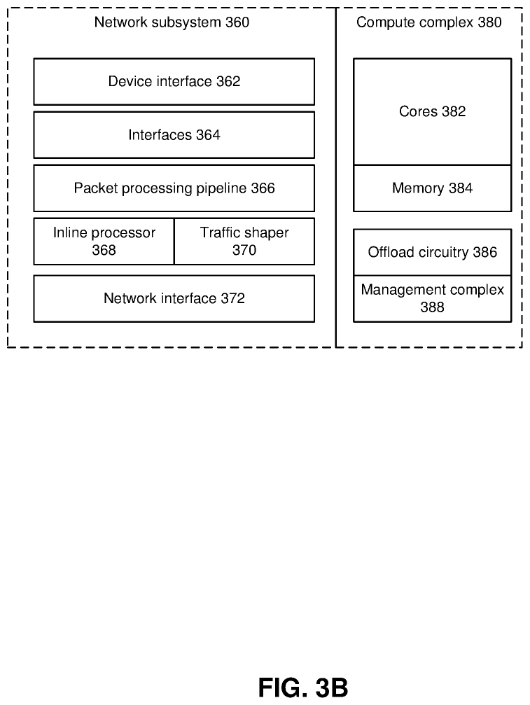

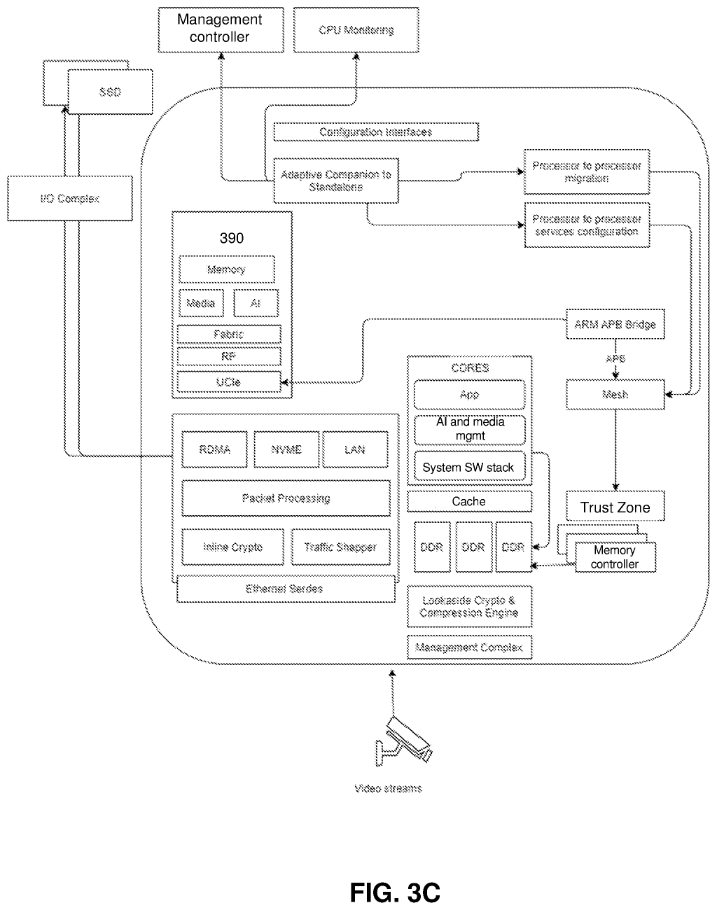

FIG. 3A depicts an example system. Host 300 can include processors, memory devices, device interfaces, as well as other circuitry such as described with respect to one or more of FIG. 3B, 7, and/or 8. Processors of host 300 can execute software such as applications (e.g., microservices, virtual machine (VMs), microVMs, containers, processes, threads, or other virtualized execution environments), operating system (OS), and device drivers. An OS or device driver can configure network interface device or packet processing device 310 to utilize one or more control planes to communicate with software defined networking (SDN) controller 350 via a network to configure operation of the one or more control planes.

Packet processing device 310 can include multiple compute complexes, such as an Acceleration Compute Complex (ACC) 320 and Management Compute Complex (MCC) 330, as well as packet processing circuitry 340 and network interface technologies for communication with other devices via a network. ACC 320 can be implemented as one or more of: a microprocessor, processor, accelerator, field programmable gate array (FPGA), application specific integrated circuit (ASIC) or circuitry described at least with respect to FIG. 3B, 7, and/or 8. Similarly, MCC 330 can be implemented as one or more of: a microprocessor, processor, accelerator, field programmable gate array (FPGA), application specific integrated circuit (ASIC) or circuitry described at least with respect to FIG. 3B, 7, and/or 8. In some examples, ACC 320 and MCC 330 can be implemented as separate cores in a CPU, different cores in different CPUs, different processors in a same integrated circuit, different processors in different integrated circuit. Packet processing device 310 can be implemented as one or more of: a microprocessor, processor, accelerator, field programmable gate array (FPGA), application specific integrated circuit (ASIC) or circuitry described at least with respect to FIG. 3B, 7, and/or 8. Packet processing pipeline circuitry 340 can process packets as directed or configured by one or more control planes executed by multiple compute complexes. In some examples, ACC 320 and MCC 330 can execute respective control planes 322 and 332.

SDN controller 350 can upgrade or reconfigure software executing on ACC 320 (e.g., control plane 322 and/or control plane 332) through contents of packets received through packet processing device 310. In some examples, ACC 320 can execute control plane operating system (OS) (e.g., Linux) and/or a control plane application 322 (e.g., user space or kernel modules) used by SDN controller 350 to configure operation of packet processing pipeline 340. Control plane application 322 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 350 can communicate with ACC 320 using a remote procedure call (RPC) such as Google remote procedure call (gRPC) or other service and ACC 320 can convert the request to target specific protocol buffer (protobuf) request to MCC 330. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 350 can provide packet processing rules for performance by ACC 320. For example, ACC 320 can program table rules (e.g., header field match and corresponding action) applied by packet processing pipeline circuitry 340 based on change in policy and changes in VMs, containers, microservices, applications, or other processes. ACC 320 can be configured to provide network policy as flow cache rules into a table to configure operation of packet processing pipeline 340. For example, the ACC-executed control plane application 322 can configure rule tables applied by packet processing pipeline circuitry 340 with rules to define a traffic destination based on packet type and content. ACC 320 can program table rules (e.g., match-action) into memory accessible to packet processing pipeline circuitry 340 based on change in policy and changes in VMs.

A flow can be a sequence of packets being transferred between two endpoints, generally representing a single session using a protocol. Accordingly, a flow can be identified, using a match, by a set of defined tuples and, for routing purpose, a flow is identified by the two tuples that identify the endpoints, e.g., the source and destination addresses. For content-based services (e.g., load balancer, firewall, Intrusion detection system etc.), flows can be identified at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

For example, ACC 320 can execute a virtual switch such as vSwitch or Open vSwitch (OVS), Stratum, or Vector Packet Processing (VPP) that provides communications between virtual machines executed by host 300 or with other devices connected to a network. For example, ACC 320 can configure packet processing pipeline circuitry 340 as to which VM is to receive traffic and what kind of traffic a VM can transmit. For example, packet processing pipeline circuitry 340 can execute a virtual switch such as vSwitch or Open vSwitch that provides communications between virtual machines executed by host 300 and packet processing device 310.

MCC 330 can execute a host management control plane, global resource manager, and perform hardware registers configuration. Control plane 332 executed by MCC 330 can perform provisioning and configuration of packet processing circuitry 340. For example, a VM executing on host 300 can utilize packet processing device 310 to receive or transmit packet traffic. MCC 330 can execute boot, power, management, and manageability software (SW) or firmware (FW) code to boot and initialize the packet processing device 310, manage the device power consumption, provide connectivity to Baseboard Management Controller (BMC), and other operations.

One or both control planes of ACC 320 and MCC 330 can define traffic routing table content and network topology applied by packet processing circuitry 340 to select a path of a packet in a network to a next hop or to a destination network-connected device. For example, a VM executing on host 300 can utilize packet processing device 310 to receive or transmit packet traffic.

ACC 320 can execute control plane drivers to communicate with MCC 330. At least to provide a configuration and provisioning interface between control planes 322 and 332, communication interface 325 can provide control-plane-to-control plane communications. Control plane 332 can perform a gatekeeper operation for configuration of shared resources. For example, via communication interface 325, ACC control plane 322 can communicate with control plane 332 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 325 can be utilized by a negotiation protocol and configuration protocol running between ACC control plane 322 and MCC control plane 332. Communication interface 325 can include a general purpose mailbox for different operations performed by packet processing circuitry 340. Examples of operations of packet processing circuitry 340 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 325 can include one or more mailboxes accessible as registers or memory addresses. For communications from control plane 322 to control plane 332, communications can be written to the one or more mailboxes by control plane drivers 324. For communications from control plane 332 to control plane 322, communications can be written to the one or more mailboxes. Communications written to mailboxes can include descriptors which include message opcode, message error, message parameters, and other information. Communications written to mailboxes can include defined format messages that convey data. Communication interface 325 can provide communications based on writes or reads to particular memory addresses (e.g., dynamic random access memory (DRAM)), registers, other mailbox that is written-to and read-from to pass commands and data. To provide for secure communications between control planes 322 and 332, registers and memory addresses (and memory address translations) for communications can be available only to be written to or read from by control planes 322 and 332 or cloud service provider (CSP) software executing on ACC 320 and device vendor software, embedded software, or firmware executing on MCC 330. Communication interface 325 can support communications between multiple different compute complexes such as from host 300 to MCC 330, host 300 to ACC 320, MCC 330 to ACC 320, baseboard management controller (BMC) to MCC 330, BMC to ACC 320, or BMC to host 300.

Packet processing circuitry 340 can be implemented using one or more of: application specific integrated circuit (ASIC), field programmable gate array (FPGA), processors executing software, or other circuitry. Control plane 322 and/or 332 can configure packet processing pipeline circuitry 340 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 320 or MCC 330. In some examples, a P4 program can be compiled and provided to MCC 330 to configure packet processing circuitry 340. The following is a JSON configuration file that can be transmitted from ACC 320 to MCC 330 to get capabilities of packet processing circuitry 340 and/or other circuitry in packet processing device 310. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

As described herein, network interface device (NID) 310 can operate in standalone mode or companion mode. NID 310 can include an interface or registers that allows configuration of a mode of operation 342 of MD 310. For example, host 300 an SDN controller 350, or other entity can configure a mode of operation of MD 310.

In standalone mode, ND 310 may execute one or more processes using ACC 320 and other circuitry (e.g., circuitry described with respect to FIG. 3B. For example, in standalone mode, NID 310 can execute one or more applications and does not utilize a CPU of host 300. In companion mode, where host 300 can offload a workload to MD 310 due to various reasons (e.g., power usage of host 300 is met or exceeded, temperature limit is met or exceeded, insufficient capacity, excessive load) and can transfer the workload (e.g., process) to NID 310 for execution.

NID 310 can operate in a standalone mode based on failure of host 300. Host 300 can expose heartbeat and operational monitoring of host 300 to NID 310 to monitor the health of host 300 (e.g., processors and/or memory). For example, NID 310 can monitor certain memory ranges or access to certain type of registers (e.g., model-specific. register (MSR)) that stores status of host 300. If NID 310 identifies that host 300 is not operating or malfunctioning (e.g., excessive temperature, insufficient power, or excessive load), NID 310 can transition to failover mode and take over perform applications formerly executed by host 300. ND 310 may migrate or instantiate the applications executed by host 300 for execution on cores or processors of ACC 320. In some cases, as cores of ACC 320 and host 300 may be different technologies (e.g., ARM in ACC 320 versus x$6 in host 300), MD 310 can utilize a table of applications to be instantiated and pointers to the ARM binaries to be launched on ACC 320. NID 310 can copy process state from storage or specific region of memory from host 300 to continue operation of a applications that formerly executed on host 300. NM 310 may coordinate with a management controller (e.g., BMC) to put host 300 (e.g., processors and/or memory) in low power state (e.g., Co state) and become the main system.

In some examples, NID 310 can operate in a standalone mode based on detecting that host interface 344 (e.g., CXL, PCIe, UPI) to host 300 is not operating or inaccessible.

In some examples, based on reducing power to a CPU of host 300 and where NID 310 operates in standalone mode to execute one or more applications formerly executed by host 300, the discrete devices connected to the CPU as endpoints (and the corresponding CXL connectivity) can be mapped to NID 310 and accessible to processors or accelerators of NID 310. Conversely, based on reducing power to a processor or accelerator of NID 310 and host 300 operates in standalone mode to execute one or more applications formerly executed by NID 310, the discrete devices connected to NID 310 as endpoints (and the corresponding CXL connectivity) can be mapped to host 300 and accessible to processors or accelerators of host 300.

In some examples, memory in host 300 can be shared between applications executing on host 300 and applications executing on NID 310. Execution pointers of specific threads can stop or start using interfaces. In such cases, state may not be migrated to NID 310, but final application state can be marked and a pointer changed from source to target system via interfaces.

An orchestrator or SDN controller 350 can trigger a seamless migration of entire active state of jobs with a stateful failover from host 300 (or another NID) to NID 310. Specifically, when using Compute Express Link (CXL) consistent memory interfaces, example failover scenarios can be as follows. Scenario (1), migrate application and application state from NID 1 to NID 2, where source and target NIDs are interconnected via CXL interfaces. Scenario (2), migrate application and application state from host 300 to NID 310 interconnected on CXL. Scenario (3), migrate application and application state from NID 310 to host 300 with NID 310 as source and host 300 as target.

In some examples, instruction semantics of a processor or accelerator in host 300 that execute an application can be compatible with instruction semantics of a processor or accelerator in NID 310 selected to execute the migrated application. In such cases, the application can be migrated from host 300 to NID 310 or instantiated on NID 310.

In some examples, instruction semantics of a processor or accelerator in host 300 that execute an application can be different from instruction semantics (e.g., (Instruction Set Architecture (ISA))) of a processor or accelerator in NID 310 selected to execute the migrated application. In such cases, an executable binary or kernel, that can execute on a selected processor or accelerator of NID 310, can be retrieved from storage or memory on NID 310 or connected to NID 310 or transmitted to NID 310 and executed on NID 310. In such cases, NID 310 can translate a binary associated with the migrated application, from host 300, to a format (e.g., ISA or kernel) that can execute on a selected processor or accelerator of NID 310. In some cases, a selected processor or accelerator of NID 310 can perform processor emulation to execute the migrated application by translating processor instructions and operating system calls as an application is running.

For migration of an application executing on NID 310 to execute on a target processor or accelerator in host 300, similar operations can occur as those for migration of an application from host 300 to NID 310 to provide an application that can be executed by a selected processor in host 300.

Example operations of failover can be as follows. At (1), application is executing on source host system 300. At (2), orchestrator triggers a failover from source system 300 to target system (e.g., NID 310). At (2A), orchestrator can attest source system 300. At (2B), orchestrator attests target system (e.g., NID 310). At (2C), attestation results are compared to determine if trust environments are approximately equal. If trust environments are approximately equal, then proceed with triggered failover. If trust environments are not approximately equal, a different target can be identified and operations 2A-2C repeated for the different target. At (3), the memory content is copied from local memory to shared memory (e.g., via CXL interface). At (4), related application is spawned on target system. At (5), memory content is copied from shared memory to target system. Content may be attested by supplying metadata that describes the environment from which the content originated as well as metadata from an environment that processed the data. Coalition for Content Provenance and Authenticity (C2PA) version 1.0 is an example standard for content exchange that can be extended to include attestation context.

At (6), execution state is suspended on source system (e.g., host 300) and is switched to target system. Source system power state can be moved to deep idle state if needed or it can continue processing other applications. At (7), resume from suspend or idle triggers layered attesting environment or Root of Trust to re-collect attestation measurements of the newly constructed execution state. If cryptographic keys are derived using Device Identity Composition Engine (DICE), then layer keys can be re-generated prior to an attestation report. Note that the failover operations can occur from NID 310 to another NID, or NID 310 to host 300 or another host system. After a migration of an application to NID 310 and detection of operation of host 300, the application can be migrated to back for execution on host 300.

For example, a processor core can be elected as primary attesting environment that runs MCHECK which queries other cores causing them to prove possession of an attestation key. The primary can attest the existence of other keys such that a verifier can perform revocation and authority checks. If ARM cores follow a similar approach, a second tier function is required that asserts a PASTE) context for tier-2 primary/lead attester that either verifies tier-1 attestations or forwards tier-1 attestations to a remote verifier (external to the host 300). The tier-2 primary can use its attestation key to sign tier-2 secondary keys (which become the tier-1 primary entities).

NID 310 may provide an end-point to devices connected into the memory complex (e.g., Compute Express Link (CXL) connected devices) of host 300. As described herein, ND 310 may be connected to a CXL fabric that provides access to discrete devices (e.g., GPU, accelerators, processors, or storage devices). In companion mode, MD 310 may not have access to the CXL: fabric, but in standalone mode, the NM 310 can access the CXL fabric so that discrete devices can be accessed.

FIG. 3B depicts an example network interface device system. Various examples of a packet processing device or network interface device 301 can utilize components of the system of FIG. 3B. In some examples, a packet processing device or a network interface device can refer to one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). Network subsystem 360 can be communicatively coupled to compute complex 380. Device interface 362 can provide an interface to communicate with a host. Various examples of device interface 362 can utilize protocols based on Peripheral Component Interconnect Express (PCIe), Compute Express Link (CXL), or others as well as virtual device interface such as virtual device interfaces.

Interfaces 364 can initiate and terminate at least offloaded remote direct memory access (RDMA) operations, Non-volatile memory express (NVMe) reads or writes operations, and LAN operations. Packet processing pipeline 366 can perform packet processing (e.g., packet header and/or packet payload) based on a configuration and support quality of service (QoS) and telemetry reporting. Inline processor 368 can perform offloaded encryption or decryption of packet communications (e.g., Internet Protocol Security (IPSec) or others). Traffic shaper 370 can schedule transmission of communications. Network interface 372 can provide an interface at least to an Ethernet network by media access control (MAC) and serializer/de-serializer (Serdes) operations.

Cores 382 can be configured to perform infrastructure operations such as storage initiator, Transport Layer Security (TLS) proxy, virtual switch (e.g., vSwitch), or other operations. Memory 384 can store applications and data to be performed or processed. Offload circuitry 386 can perform at least cryptographic and compression operations for host or use by compute complex 380. Offload circuitry 386 can include one or more graphics processing units (GPUs) that can access memory 384. Management complex 388 can perform secure boot, life cycle management and management of network subsystem 360 and/or compute complex 380.

FIG. 3C depicts an example system. Medial/AI tile circuitry 390 can be integrated into a network interface device. Media/AI circuitry 390 can be activated or deactivated by a configuration from an orchestrator or administrator and, when active, media/AI circuitry 390 can be accessed by a network interface device. Media/AI circuitry 390 can utilize one root port (RP) to read or write from a memory subsystem (e.g., Double Data Rate (DDR) compatible memory and cache). A bridge from the Media/AI circuitry 390 into ARM subsystem can be provided by APB. Memory traffic from Media/IP tile 390 can be transmitted using ARM compatible Advanced Peripheral Bus (APB) into ab ARM subsystem. Input-Output Memory Management Unit (IOMMU) can provide memory address translation between the devices.

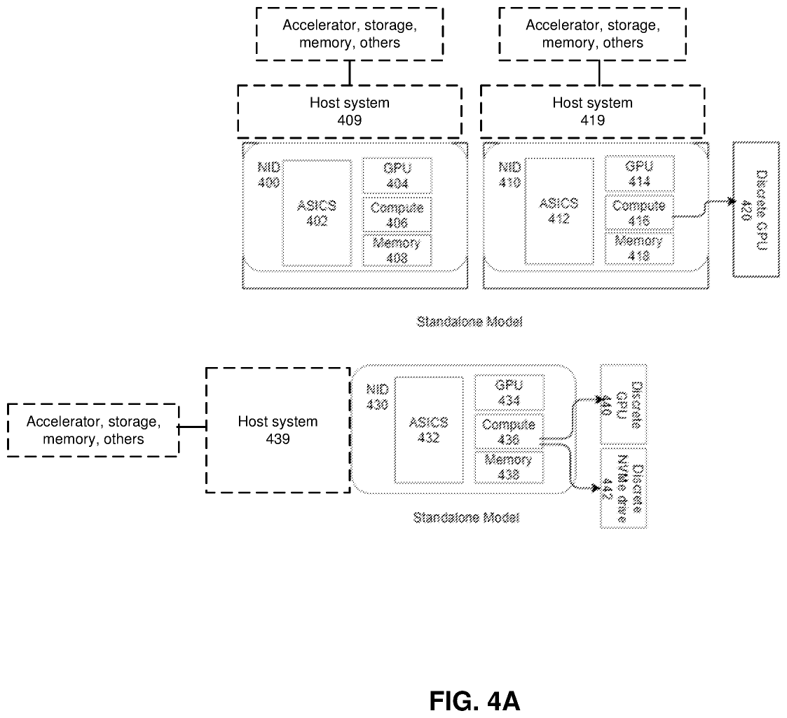

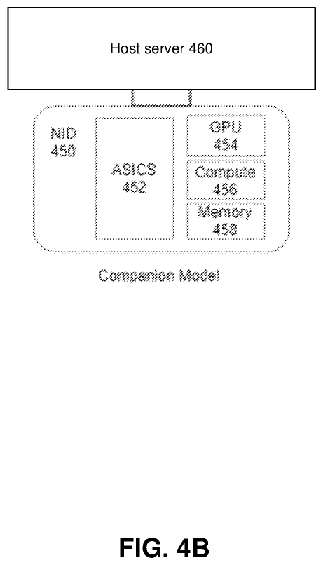

FIGS. 4A and 4B depict example configurations. A network interface device can operate as a standalone computing platform or counterpart to a computing platform depending on the deployment model. FIG. 4A depicts multiple standalone model configurations. Applications executing on compute 406 (e.g., processors) of NID 400 can utilize ASICs 402, GPU 404, and memory 408 to perform operations.

Applications executing on compute 416 (e.g., processors) of NID 410 can utilize ASICs 412, GPU 414, memory 418, and discrete GPU 420 connected to NID 410 via a device interface (e.g., PCIe or CXL) to perform operations.

Applications executing on compute 436 (e.g., processors) of NID 410 can utilize ASICs 432, GPU 434, memory 438, and discrete GPU 440 and discrete NVMe storage drives connected to NID 410 via a device interface (e.g., PCIe or CXL) to perform operations.

Note that in one or more standalone modes, host system connected to a NID can remain connected to a NID but powered down or in reduce power mode. Discrete devices connected to a host can be accessible to the NID, in some examples. For example, host system 409 communicatively coupled to NID 400 can provide access to discrete devices (e.g., accelerator, storage, memory, GPU, or others) to NID 400. For example, host system 419 communicatively coupled to NID 410 can provide access to discrete devices (e.g., accelerator, storage, memory, GPU, or others) to NID 410. Similarly, host system 439 communicatively coupled to NID 430 can provide access to discrete devices (e.g., accelerator, storage, memory, GPU, or others) to NID 430.

When a core or CPU of a host reduces power or is powered off, discrete devices that were exposed as endpoints to the CPU (and the corresponding CXL functionalities) can be mapped to the NID and accessible to cores or processors of the NID.

FIG. 4B depicts an example companion model configuration. Host server 460 can execute one or more application that utilize resources of NID 450 (e.g., ASICS 452, GPU 454, compute 456, and/or memory 458).

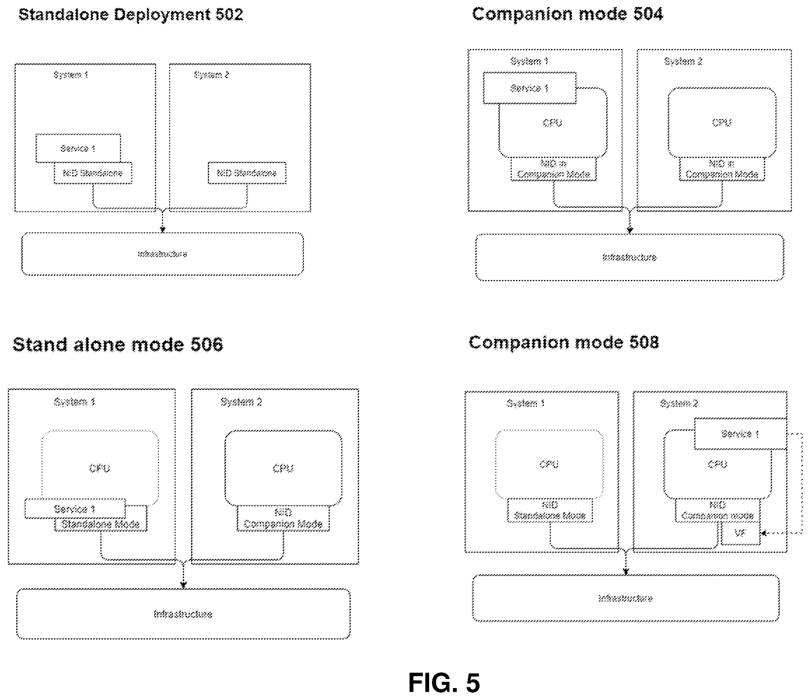

FIG. 5 depicts an example of service migration. Scenario 502 includes a standalone deployment of service on NID infrastructure. Scenario 504 includes a service 1 utilizing CPU compute capacity to perform compute operations. Scenario 506 includes service 1 compute demand substantially reducing and system may attempt power savings (e.g., to reduce battery usage). Accordingly, NID on Edge 1 migrates Service 1 to its cores, changes to Standalone mode, and CPU enters lower power state. In scenario 506, service 1 executing on the NID in the standalone mode can access storage and GPUs connected to CPU via PCIe or other interface. PCIe connected devices can act as a root port for NID instead of, or in addition to, being exposed to the host.

At 508, Service 1 compute demand increases but Edge 1 cannot provide the energy to resume the Service 1 in the CPU. NIDs in Edge 1 and Edge 2 communicate to migrate Service 1 to CPU on Edge 2. NID on Edge 1 remains in Standalone mode and NID on Edge 2 exposes media and AI processors as VF to CPU on Edge 2 to perform operations of Service 1.

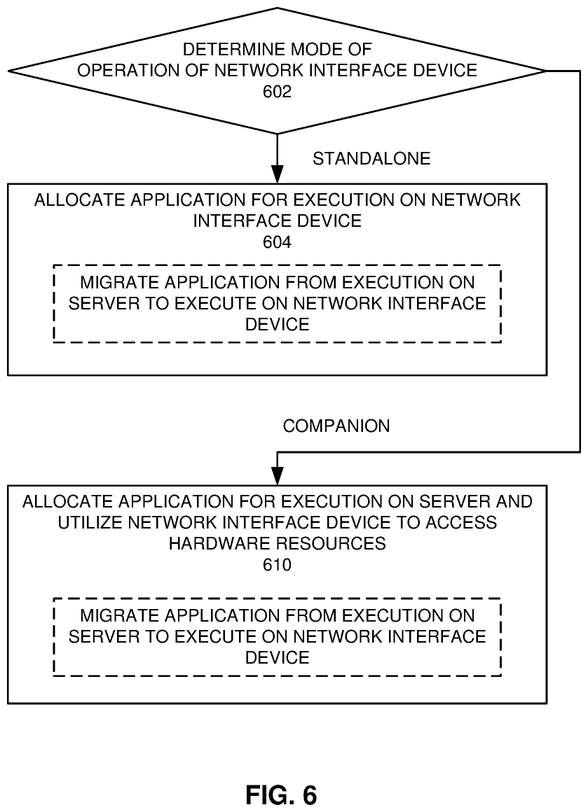

FIG. 6 depicts an example process. The process can be performed by an orchestrator. At 602, a determination can be made of a mode of operation of a network interface device. For example, the network interface device can operate in a companion mode or standalone mode. Based on the network interface device operating in a standalone mode, the process can proceed to 604. Based on the network interface device operating in a companion mode, the process can proceed to 610.

At 604, in a standalone mode, an application can be allocated for execution solely on the network interface device. For example, the application can execute on processors of the network interface device and utilize circuitry in the network interface device to perform media processing and inference operations. In some examples, the network interface device can be selected to execute an application that was migrated from a server or formerly executed by a server. Application state data can be migrated or copied to the network interface device from the server. In some examples, an orchestrator or the network interface device can detect failure of the server and cause migration of the application and associated state to the network interface device.

At 610, in a companion mode, an application can be allocated for execution on a server and can utilize hardware resources of the network interface device. For example, the server and network interface device can be communicatively coupled using a network, memory interface (e.g., CXL), or device interface (e.g., PCIe). In some examples, the network interface device can be selected to execute an application that was migrated from a server or formerly executed by a server. Various technologies for application and state migration are described herein.

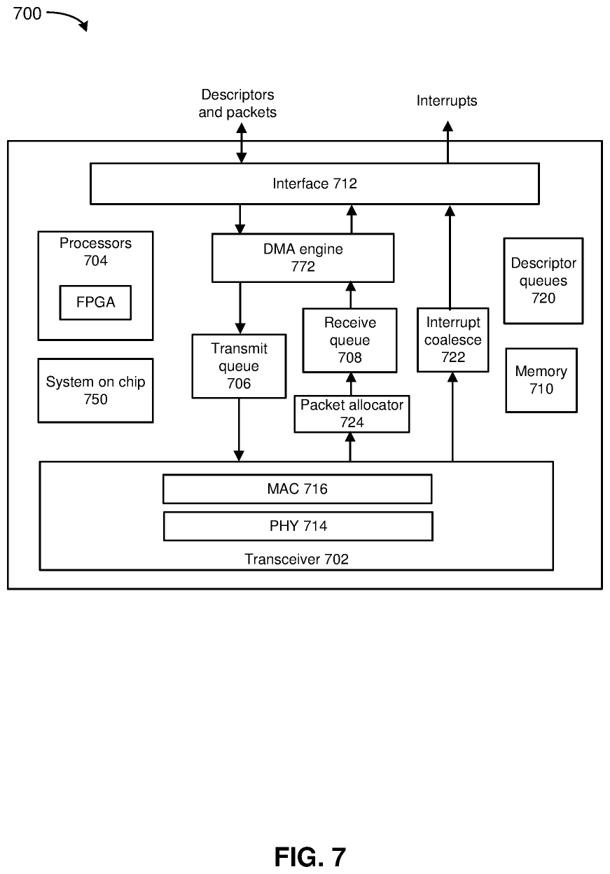

FIG. 7 depicts an example network interface device or packet processing device. In some examples, circuitry of network interface device can be utilized to execute applications or provide hardware resources in standalone or companion modes, as described herein. In some examples, packet processing device 700 can be implemented as a network interface controller, network interface card, a host fabric interface (HFI), or host bus adapter (HBA), and such examples can be interchangeable. Packet processing device 700 can be coupled to one or more servers using a bus, PCIe, CXL, or Double Data Rate (DDR). Packet processing device 700 may be embodied as part of a system-on-a-chip (SoC) that includes one or more processors, or included on a multichip package that also contains one or more processors.

Some examples of packet processing device 700 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 700 can include transceiver 702, processors 704, transmit queue 706, receive queue 708, memory 710, and host interface 712, and DMA engine 772. Transceiver 702 can be capable of receiving and transmitting packets in conformance with the applicable protocols such as Ethernet as described in IEEE 802.3, although other protocols may be used. Transceiver 702 can receive and transmit packets from and to a network via a network medium (not depicted). Transceiver 702 can include PHY circuitry 714 and media access control (MAC) circuitry 716. PHY circuitry 714 can include encoding and decoding circuitry (not shown) to encode and decode data packets according to applicable physical layer specifications or standards. MAC circuitry 716 can be configured to assemble data to be transmitted into packets, that include destination and source addresses along with network control information and error detection hash values.

System on chip (SoC) 750 and processors 704 can be any a combination of a: processor, core, graphics processing unit (GPU), field programmable gate array (FPGA), application specific integrated circuit (ASIC), or other programmable hardware device that allow programming of network interface 700. For example, a “smart network interface” can provide packet processing capabilities in the network interface using processors 704.

Processors 704 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 704, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

Packet allocator 724 can provide distribution of received packets for processing by multiple CPUs or cores using timeslot allocation described herein or RSS. When packet allocator 724 uses RSS, packet allocator 724 can calculate a hash or make another determination based on contents of a received packet to determine which CPU or core is to process a packet.

Interrupt coalesce 722 can perform interrupt moderation whereby network interface interrupt coalesce 722 waits for multiple packets to arrive, or for a time-out to expire, before generating an interrupt to host system to process received packet(s). Receive Segment Coalescing (RSC) can be performed by network interface 700 whereby portions of incoming packets are combined into segments of a packet. Network interface 700 provides this coalesced packet to an application.

Direct memory access (DMA) engine 772 can copy a packet header, packet payload, and/or descriptor directly from host memory to the network interface or vice versa, instead of copying the packet to an intermediate buffer at the host and then using another copy operation from the intermediate buffer to the destination buffer.

Memory 710 can be any type of volatile or non-volatile memory device and can store any queue or instructions used to program network interface 700. Transmit queue 706 can include data or references to data for transmission by network interface. Receive queue 708 can include data or references to data that was received by network interface from a network. Descriptor queues 720 can include descriptors that reference data or packets in transmit queue 706 or receive queue 708. Host interface 712 can provide an interface with host device (not depicted). For example, host interface 712 can be compatible with PCI, PCI Express, PCI-x, Serial ATA, and/or USB compatible interface (although other interconnection standards may be used).

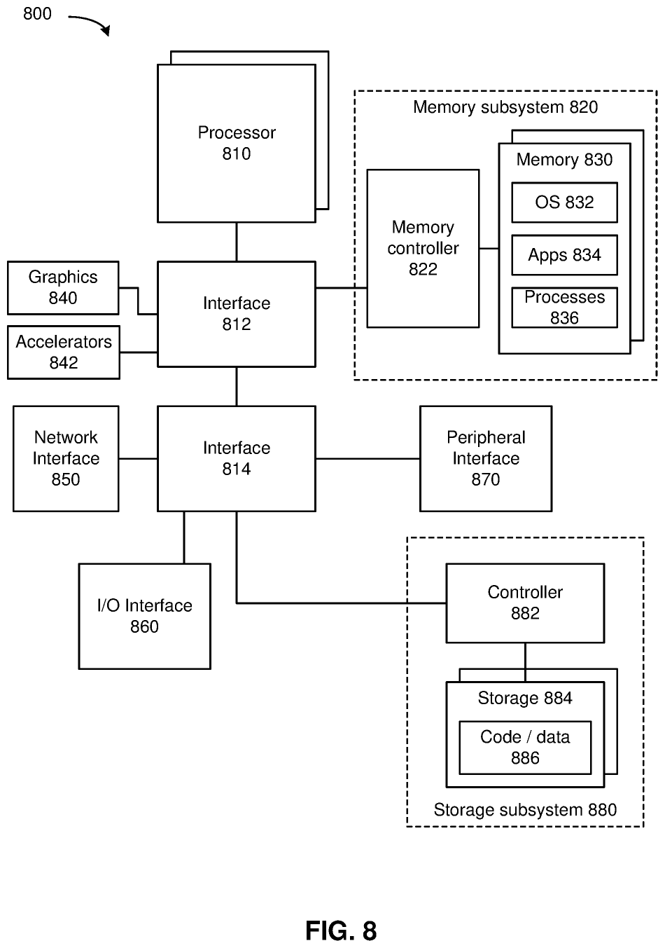

FIG. 8 depicts a system. In some examples, circuitry of network interface device can be utilized to execute applications or provide hardware resources in standalone or companion modes, as described herein. System 800 includes processor 810, which provides processing, operation management, and execution of instructions for system 800. Processor 810 can include any type of microprocessor, central processing unit (CPU), graphics processing unit (GPU), XPU, processing core, or other processing hardware to provide processing for system 800, or a combination of processors. An XPU can include one or more of: a CPU, a graphics processing unit (GPU), general purpose GPU (GPGPU), and/or other processing units (e.g., accelerators or programmable or fixed function FPGAs). Processor 810 controls the overall operation of system 800, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 800 includes interface 812 coupled to processor 810, which can represent a higher speed interface or a high throughput interface for system components that needs higher bandwidth connections, such as memory subsystem 820 or graphics interface components 840, or accelerators 842. Interface 812 represents an interface circuit, which can be a standalone component or integrated onto a processor die. Where present, graphics interface 840 interfaces to graphics components for providing a visual display to a user of system 800. In one example, graphics interface 840 can drive a display that provides an output to a user. In one example, the display can include a touchscreen display. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a programmable or fixed function offload engine that can be accessed or used by a processor 810. For example, an accelerator among accelerators 842 can provide data compression (DC) capability, cryptography services such as public key encryption (PKE), cipher, hash/authentication capabilities, decryption, or other capabilities or services. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 842 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 820 represents the main memory of system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

Applications 834 and/or processes 836 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 832 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides system 800 the ability to communicate with remote devices (e.g., servers or other computing devices) over one or more networks. Network interface 850 can include an Ethernet adapter, wireless interconnection components, cellular network interconnection components, USB (universal serial bus), or other wired or wireless standards-based or proprietary interfaces. Network interface 850 can transmit data to a device that is in the same data center or rack or a remote device, which can include sending data stored in memory. Network interface 850 can receive data from a remote device, which can include storing received data into memory. In some examples, packet processing device or network interface device 850 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described with respect to FIG. 7.

In one example, system 800 includes one or more input/output (I/O) interface(s) 860. I/O interface 860 can include one or more interface components through which a user interacts with system 800. Peripheral interface 870 can include any hardware interface not specifically mentioned above. Peripherals refer generally to devices that connect dependently to system 800.

In one example, system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (e.g., the value is retained despite interruption of power to system 800). Storage 884 can be generically considered to be a “memory,” although memory 830 is typically the executing or operating memory to provide instructions to processor 810. Whereas storage 884 is nonvolatile, memory 830 can include volatile memory (e.g., the value or state of the data is indeterminate if power is interrupted to system 800). In one example, storage subsystem 880 includes controller 882 to interface with storage 884. In one example controller 882 is a physical part of interface 814 or processor 810 or can include circuits or logic in both processor 810 and interface 814.

A volatile memory is memory whose state (and therefore the data stored in it) is indeterminate if power is interrupted to the device. A non-volatile memory (NVM) device is a memory whose state is determinate even if power is interrupted to the device.

In an example, system 800 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 800 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: a network interface device comprising: a network interface, a direct memory access (DMA) circuitry, a host interface, memory, one or more processors, and circuitry to: based on a configuration of operation specifying a standalone operation, cause the network interface device to operate in standalone to execute one or more applications and based on a configuration of operation specifying a companion operation, cause the network interface device to operate in companion to provide at least one host system with access to one or more hardware resources accessible by the network interface device.

Example 2 includes one or more examples and includes second circuitry to perform video analysis operations and wherein the second circuitry is activated or deactivate based on a request to active or deactivate the second circuitry.

Example 3 includes one or more examples, wherein the circuitry is to: monitor operation of a host system to determine if one or more processors of the host system that execute particular process are operational and based on a determination that the one or more processors of the host system are not operational, access memory of the host system to perform a failover operation to cause the particular process to execute on the one or more processors of the network interface device and to copy state data associated with the particular process from the memory of the host system and/or from non-operational processors to the memory of the network interface device.

Example 4 includes one or more examples, wherein the circuitry is to perform binary translation of the particular process or processor emulation for execution on the one or more processors of the network interface device.

Example 5 includes one or more examples, wherein the circuitry is to: after the cause the particular process to execute on the one or more processors and copy state data of the particular process from the memory of the host system to the memory of the network interface device, based on detection of operation of at least one of the one or more processors of the host system, cause execution of the particular process on the at least one of the one or more processors of the host system.

Example 6 includes one or more examples, wherein the circuitry is to: after the cause the particular process to execute on the one or more processors and copy state data of the particular process from the memory of the host system to memory of the network interface device, based on detection of operation of at least one processor of a second network interface device, cause execution of the particular process on the at least one processor of the second network interface device.

Example 7 includes one or more examples, wherein the particular process comprises one or more of: a virtual machine, a container, or a microservice.

Example 8 includes one or more examples, wherein the network interface device comprises circuitry to select a binary for the particular process that is compatible with the one or more processors of the network interface device.

Example 9 includes one or more examples, wherein the network interface device is to access operational state of the at least one host system and the state data of one or more of: memory, registers, or cache of the at least one host system via a secure connection.

Example 10 includes one or more examples, and includes a non-transitory computer-readable medium comprising instructions stored thereon, that if executed by one or more processors, cause the one or more processors to: configure a network interface device to operate as standalone computing platform to execute one or more applications or operate as a companion to provide at least one host system with access to one or more hardware resources accessible by the network interface device, wherein the network interface device is to detect whether a host interface is present and based on lack of access to the host interface, operate as the standalone computing platform and the network interface device comprises a network interface, a direct memory access (DMA) circuitry, and a host interface.

Example 11 includes one or more examples, wherein the network interface device comprises circuitry to perform video analysis operations and wherein the circuitry is active or deactivated based on a request to active or deactivate the circuitry.

Example 12 includes one or more examples, and includes instructions stored thereon, that if executed by one or more processors, cause the one or more processors to: configure the network interface device to monitor operation of a host system to determine if one or more processors of the host system that execute particular process are operational and based on a determination that the one or more processors of the host system are not operational, access memory of the host system to perform a failover operation to cause the particular process to execute on the one or more processors of the network interface device and to copy state data associated with the particular process from the memory of the host system to the memory of the network interface device.

Example 13 includes one or more examples, and includes instructions stored thereon, that if executed by one or more processors, cause the one or more processors to: select an executable binary associated with the particular process for execution on the one or more processors of the network interface device.

Example 14 includes one or more examples, and includes instructions stored thereon, that if executed by one or more processors, cause the one or more processors to: after the cause the particular process to execute on the one or more processors and copy state data of the particular process from the memory of the host system to the memory of the network interface device, based on detection of operation of at least one of the one or more processors of the host system, cause execution of the particular process on the at least one of the one or more processors of the host system.

Example 15 includes one or more examples, and includes instructions stored thereon, that if executed by one or more processors, cause the one or more processors to: after the cause the particular process to execute on the one or more processors and copy state data of the particular process from the memory of the host system to memory of the network interface device, based on detection of operation of at least one processor of a second network interface device, cause execution of the particular process on the at least one processor of the second network interface device.

Example 16 includes one or more examples, and includes a method that includes: an orchestrator performing: causing execution of an application on one or more of server or a network interface device, wherein the network interface device comprises a network interface, a direct memory access (DMA) circuitry, and a host interface and wherein the network interface device operates in a standalone operation to execute one or more applications or operate as a companion to provide at least one host system with access to one or more hardware resources accessible by the network interface device.

Example 17 includes one or more examples, and includes monitoring operation of a host system to determine if one or more processors of the host system that execute particular process are operational and based on a determination that the one or more processors of the host system are not operational, accessing memory of the host system to perform a failover operation to cause the particular process to execute on the one or more processors of the network interface device and to copy state data associated with the particular process from the memory of the host system to the memory of the network interface device.

Example 18 includes one or more examples, and includes selecting an executable binary associated with the particular process for execution on the one or more processors of the network interface device.

Example 19 includes one or more examples, and includes after the cause the particular process to execute on the one or more processors and copy state data of the particular process from the memory of the host system to the memory of the network interface device, based on detection of operation of at least one of the one or more processors of the host system, cause execution of the particular process on the at least one of the one or more processors of the host system.

Example 20 includes one or more examples, and includes accessing operational state of the at least one host system and the state data of one or more of: memory, registers, or cache of the at least one host system via a secure connection.

1. An apparatus comprising:
a network interface device comprising:
a network interface,
a direct memory access (DMA) circuitry,
a host interface,
memory,
one or more processors, and
circuitry to:
based on a configuration of operation specifying a standalone operation, cause the network interface device to operate in standalone to execute one or more applications and based on a configuration of operation specifying a companion operation,
cause the network interface device to operate in companion to provide at least one host system with access to one or more hardware resources accessible by the network interface device.

2. The apparatus of claim 1, comprising second circuitry to perform video analysis operations and wherein the second circuitry is activated or deactivate based on a request to active or deactivate the second circuitry.

3. The apparatus of claim 1, wherein the circuitry is to:
monitor operation of a host system to determine if one or more processors of the host system that execute particular process are operational and
based on a determination that the one or more processors of the host system are not operational, access memory of the host system to perform a failover operation to cause the particular process to execute on the one or more processors of the network interface device and to copy state data associated with the particular process from the memory of the host system and/or from non-operational processors to the memory of the network interface device.

4. The apparatus of claim 3, wherein the circuitry is to perform binary translation of the particular process or processor emulation for execution on the one or more processors of the network interface device.

5. The apparatus of claim 3, wherein the circuitry is to:
after the cause the particular process to execute on the one or more processors and copy state data of the particular process from the memory of the host system to the memory of the network interface device, based on detection of operation of at least one of the one or more processors of the host system, cause execution of the particular process on the at least one of the one or more processors of the host system.

6. The apparatus of claim 3, wherein the circuitry is to:
after the cause the particular process to execute on the one or more processors and copy state data of the particular process from the memory of the host system to memory of the network interface device, based on detection of operation of at least one processor of a second network interface device, cause execution of the particular process on the at least one processor of the second network interface device.

7. The apparatus of claim 3, wherein the particular process comprises one or more of: a virtual machine, a container, or a microservice.

8. The apparatus of claim 3, wherein the network interface device comprises circuitry to select a binary for the particular process that is compatible with the one or more processors of the network interface device.

9. The apparatus of claim 3, wherein the network interface device is to access operational state of the at least one host system and the state data from one or more of: memory, registers, or cache of the at least one host system, via a secure connection.

10. A non-transitory computer-readable medium comprising instructions stored thereon, that if executed by one or more processors, cause the one or more processors to:
configure a network interface device to operate as standalone computing platform to execute one or more applications or operate as a companion to provide at least one host system with access to one or more hardware resources accessible by the network interface device, wherein
the network interface device is to detect whether a host interface is present and based on lack of access to the host interface, operate as the standalone computing platform and
the network interface device comprises a network interface, a direct memory access (DMA) circuitry, and a host interface.

11. The computer-readable medium of claim 10, wherein the network interface device comprises circuitry to perform video analysis operations and wherein the circuitry is active or deactivated based on a request to active or deactivate the circuitry.

12. The computer-readable medium of claim 10, comprising instructions stored thereon, that if executed by one or more processors, cause the one or more processors to:
configure the network interface device to
monitor operation of a host system to determine if one or more processors of the host system that execute particular process are operational and
based on a determination that the one or more processors of the host system are not operational, access memory of the host system to perform a failover operation to cause the particular process to execute on the one or more processors of the network interface device and to copy state data associated with the particular process from the memory of the host system to the memory of the network interface device.

13. The computer-readable medium of claim 12, comprising instructions stored thereon, that if executed by one or more processors, cause the one or more processors to:
select an executable binary associated with the particular process for execution on the one or more processors of the network interface device.

14. The computer-readable medium of claim 12, comprising instructions stored thereon, that if executed by one or more processors, cause the one or more processors to:
after the cause the particular process to execute on the one or more processors and copy state data of the particular process from the memory of the host system to the memory of the network interface device, based on detection of operation of at least one of the one or more processors of the host system, cause execution of the particular process on the at least one of the one or more processors of the host system.

15. The computer-readable medium of claim 12, comprising instructions stored thereon, that if executed by one or more processors, cause the one or more processors to:
after the cause the particular process to execute on the one or more processors and copy state data of the particular process from the memory of the host system to memory of the network interface device, based on detection of operation of at least one processor of a second network interface device, cause execution of the particular process on the at least one processor of the second network interface device.

16. A method comprising:
an orchestrator performing:
causing execution of an application on one or more of server or a network interface device, wherein the network interface device comprises a network interface, a direct memory access (DMA) circuitry, and a host interface and wherein the network interface device operates in a standalone operation to execute one or more applications or operate as a companion to provide at least one host system with access to one or more hardware resources accessible by the network interface device.

17. The method of claim 16, comprising:
monitoring operation of a host system to determine if one or more processors of the host system that execute particular process are operational and
based on a determination that the one or more processors of the host system are not operational, accessing memory of the host system to perform a failover operation to cause the particular process to execute on the one or more processors of the network interface device and to copy state data associated with the particular process from the memory of the host system to the memory of the network interface device.

18. The method of claim 17, comprising:
selecting an executable binary associated with the particular process for execution on the one or more processors of the network interface device.

19. The method of claim 17, comprising:
after the cause the particular process to execute on the one or more processors and copy state data of the particular process from the memory of the host system to the memory of the network interface device, based on detection of operation of at least one of the one or more processors of the host system, cause execution of the particular process on the at least one of the one or more processors of the host system.

20. The method of claim 17, comprising:
accessing operational state of the at least one host system and the state data from one or more of: memory, registers, or cache of the at least one host system, via a secure connection.
